(19) United States
(12) Patent Application Publication
(10) Pub. No.: US 2007/0133899 A1
(43) Pub. Date: Jun. 14, 2007

(54) Triggering an image processing function

(76) Inventors: Barinder Singh Rai, Surrey (CA); Phil Van Dyke, Surrey (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/299,218

(22) Filed: Dec. 9, 2005

(51) Int. Cl. G06K 9/36

(52) U.S. Cl. 382/276

(57) ABSTRACT

The invention is directed to apparatus, methods, and systems for calculating parameters from particular pixel components of first and second frames, and triggering a function pertaining to the image processing of a later-created frame if a particular difference between the two parameters is detected. In one embodiment, the present invention is directed to a method for triggering a processing function for a frame of image data. The method includes: (a) calculating a first parameter from pixels of a first region of a first frame; (b) calculating a second parameter from pixels of a corresponding second region of a second frame; (c) comparing the first parameter with the second parameter; and (d) triggering a function if a particular difference between the first and second parameters is detected. The calculating of the first parameter includes summing at least one particular component of the pixels of the first region. The calculating of the second parameter includes summing the particular component of the pixels of the second region. The triggered function pertains to processing at least one later-created frame that is created subsequent to the first and second frames.

### FIELD OF THE INVENTION

The present invention relates generally to the field of digital image processing. More specifically, the invention relates to calculating parameters from particular pixel components of first and second regions of first and second frames, and triggering a function pertaining to the image processing of a later-created frame if a particular difference between the two parameters is detected.

### BACKGROUND

To capture an image, digital cameras employ an image sensor, such as a charge-coupled-device (“CCD”) sensor or a complementary-metal-oxide-semiconductor (“CMOS”) sensor. The image sensor is tyically capable of ouputting frames in several different resolutions. For example, when the sensor is active, it may produce a stream of low resolution frames that are rendered on a small display screen in the camera as a video image. When viewing the video, if the user wishes to take a picture, he depresses a “shutter button” that causes the sensor to switch to outputting high-resolution frames. After the resolution switches, one of the high-resolution frames is stored in a memory as a “still image” or picture.

In some circumstances, one would like to be able to take a picture without having to depress the shutter button. For example, several people may want their picture taken as a group. One person frames the group in the camera's field of view and focuses the lens. Afterwards, when the person joins the group so as to be included in the picture, he is unable to depress the shutter button. In another circumstance, one may wish to photograph wildlife in their natural habitat. Again the desired scene is framed and focused, and the person then waits for the animal to enter the field of view. However, the animal may only be present in the field of view for a few minutes a week, and it is impractical and inconvenient to wait many hours for the animal enter the field of view. In these and other situations, it would be desirable to be able to have another way of taking a picture without depressing the shutter button.

One known method for triggering a camera to take a picture is by use of a timer. A timer, however, requires that the picture be taken at a predetermined time. Thus, a timer limits flexibility when taking group photographs, and would not be useful for capturing images of wildlife as there is no way of knowing in advance when the animal will be present in the field of view. Another known method for triggering a camera to take a picture employs a motion sensor. A motion sensor, however, adds an additional component to the camera and increases the weight, cost, and power consumption associated with the camera. This is particularly disadvantageous in portable, battery powered appliances, such camera-equiped mobile telephones. Further, a motion sensor triggers the camera to take a picture if there is motion anywhere within the field of view. This can result in pictures being taken in response to the movement of objects other than the desired object. It would be desriable if the camera does not take a picture in response to scene changes that are not of interest.

Accordingly, there is a need for automatically triggering an image processing function that does not suffer from the foregoing and other limitations.

### SUMMARY

The invention is directed to apparatus, methods, and systems for calculating parameters from particular pixel components of first and second regions of first and second frames, and triggering a function pertaining to the image processing of a later-created frame if a particular difference between the two parameters is detected.

In one embodiment, the present invention is directed to a method for triggering a processing function for a frame of image data. The method includes: (a) calculating a first parameter from pixels of a first region of a first frame; (b) calculating a second parameter from pixels of a corresponding second region of a second frame; (c) comparing the first parameter with the second parameter; and (d) triggering a function if a particular difference between the first and second parameters is detected. The calculating of the first parameter includes summing at least one particular component of the pixels of the first region. The calculating of the second parameter includes summing the particular component of the pixels of the second region. The triggered function pertains to processing at least one later-created frame that is created subsequent to the first and second frames

In another embodiment, the present invention is directed to a display controller for use in an image processing system. The display controller includes a parameter memory and a triggering unit. The triggering unit includes: (a) a calculating element and (b) a comparing element. The parameter memory is for storing parameters for delineating a first region of a first frame, a pixel component parameter for specifying at least one particular component, a first parameter, and at least one comparison threshold. The calculating element is for calculating the first parameter from pixels of the first region of the first frame and a second parameter from pixels of a corresponding second region of a second frame. In addition, the calculating element is for storing the first parameter in the memory. Further, the calculation performed by the calculating element includes summing pixel components. The comparing element is for comparing the first parameter with the second parameter and for a causing a function to be triggered if at least a first condition is satisfied. The first condition is that a difference between the first and second parameters exceeds the comparison threshold. In addition, the comparing element is adapted for triggering a function that pertains to processing at least one later-created frame created subsequent to the first and second frames.

In yet another embodiment, the present invention is directed to a computer system, comprising: a host, a display device, an image capture device, and a display controller. The display controller includes: a parameter memory, an image memory, and a triggering unit. The parameter memory is for storing parameters for delineating a first region of a first frame, a pixel component parameter for specifying at least one particular component, a first parameter, and at least one comparison threshold. The triggering unit includes a calculating element and a comparing element. The calculating element is for calculating the first parameter from pixels of the first region of the first frame and a second parameter from pixels of a corresponding second region of a second frame. In addition, the calculating element is for storing the first parameter in the memory. The calculation performed by the calculating element includes summing pixel components. The comparing element is for comparing the first parameter with the second parameter and for a causing a function to be triggered if a difference between the first and second parameters exceeds the comparison threshold. The comparing element is adapted for triggering a function that pertains to processing at least one later-created frame created subsequent to the first and second frames.

In another embodiment, the present invention is directed to computer readable code embodied on a computer readable medium for performing a method for triggering a processing function for a frame of image data. The method includes: (a) calculating a first parameter from pixels of a first region of a first frame; (b) calculating a second parameter from pixels of a corresponding second region of a second frame; (c) comparing the first parameter with the second parameter; and (d) triggering a function if a particular difference between the first and second parameters is detected. The calculating of the first parameter includes summing at least one particular component of the pixels of the first region. The calculating of the second parameter includes summing the particular component of the pixels of the second region. The triggered function pertains to processing at least one later-created frame that is created subsequent to the first and second frames.

Other aspects and advantages of the invention will become apparent from the following detailed description, taken in conjunction with the accompanying drawings, illustrating by way of example the principles of the invention.

### BRIEF DESCRIPTION OF THE DRAWINGS

FIG. 1 is a diagram of an exemplary frame and an exemplary defined region of the frame.

FIG. 2 shows a flow diagram of a preferred method for defining parameters according to the present invention.

FIG. 3 shows a flow diagram of a preferred method for triggering an image processing function according to the present invention.

FIG. 4 is a diagram of exemplary first and second frames having first and second defined regions according to the present invention.

FIG. 5 is a diagram of another pair of exemplary first and second frames having first and second defined regions according to the present invention.

FIG. 6 is a block diagram of a preferred digital imaging and display system according to the present invention.

FIG. 7 is a diagram of a camera-equipped mobile telephone illustrating one preferred context for the present invention.

### DETAILED DESCRIPTION OF PREFERRED EMBODIMENTS

The preferred embodiments of the present invention described below are directed to methods, systems, and devices for calculating parameters from particular pixel components of first and second frames, and triggering a function pertaining to the image processing of a later-created frame if a particular difference between the two parameters is detected. One skilled in the art will recognize, however, that the present invention may be practiced without some or all of the specific details described below. In addition, one skilled in the art will understand well known processes and operations have not been described in detail herein in order not to unnecessarily obscure the present invention. Reference will now be made in detail to preferred embodiments of the invention, examples of which are illustrated in the accompanying drawings. Wherever possible, the same reference numbers are used in the drawings and the description to refer to the same or like parts.

A digital image on a display screen is formed from an array of small discrete elements (“pixels.”) Digital images are often referred to as frames, and a digital camera is commonly used for capturing frames. As used herein, the phrase “field of view” refers to the amount (vertically and horizontally) of a given scene that is captured by a digital camera. The attributes of each pixel, such as its brightness and color, are represented by a numeric value, which is typically represented in binary form. For convenience of explanation and in accordance with the use of the term in the art, the term pixel is used herein to refer at times to the display elements of a display device, at times to the binary elements of data that are stored and manipulated within an image processing and display system and which define the attributes of such display elements, and at times to both, the appropriate sense of the term being clear from the context.

Pixels may be defined in more than one color model (a mathematical model for describing a gamut of colors). Color display devices generally require that pixels be defined by an RGB color model. However, other color models, such as a YUV model can be more efficient than the RGB model for processing image data. In the RGB model, each pixel is defined by a red, green, and blue component. In the YUV model, each pixel is defined by a brightness component (Y), and two color components (U, V). In color models, each component is typically represented by 8 bits and can take an integer value from 0 to 255. Thus, pixels are typically represented by 24 bits, which when the color components are added together produce a pixel in any one of over 16 million colors.

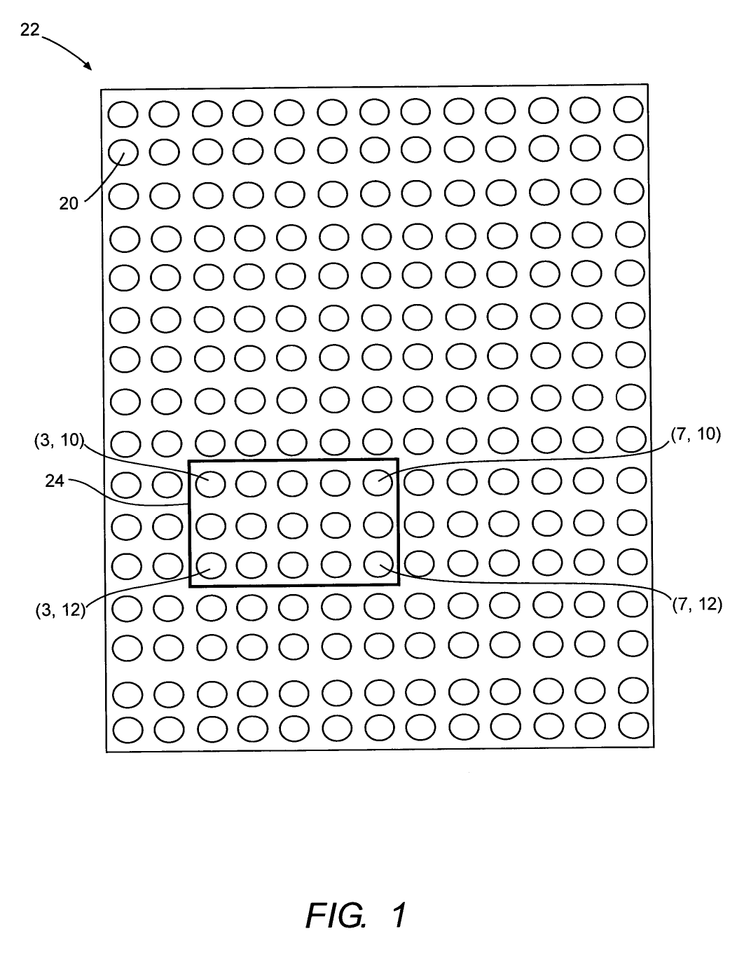

One aspect of the present invention is directed to calculating parameters from particular pixel components of first and second frames. In particular, the parameters are calculated from a defined region of the frames. An exemplary full frame 22 and an exemplary defined region 24 are illustrated in FIG. 1. The frame 22 is a 13×16 array of pixels 20, and the region 24 is a 5×3 pixel array. Typically, the frame 22 is larger than shown in FIG. 1. For instance, one common size for a frame is a 640×480. The defined region 24 may be larger, smaller, or the same size as depicted, as desired, and may be positioned anywhere within the frame 22. While the region 24 is preferably rectangular, in alternative embodiments it is defined by a curved perimeter forming, for example, a circle, an ellipse, or an irregular curved area. Moreover, the perimeter may be a combination of curved and straight lines. It is preferable, however, that the region 24 be a subset of the full frame 22. For example, the shown frame 22 has 208 pixels. Thus, the preferable maximum number of pixels that the region 24 may have is 207 pixels. In FIG. 1, the region 24 includes pixels in columns 3 to 7 that are also in rows 10 to 12, i.e., the corner pixels for the region 24 are: (3, 10), (7, 10), (3, 12), and (7, 12).

According to a preferred embodiment of the invention, a first parameter is calculated by summing the values of a particular component for all pixels located within a first defined region of a first full frame. Thereafter, a second parameter is calculated by summing the values of the same component for all pixels located within a second defined region of a second full frame. Preferably, both the first and second regions correspond to the same coordinate locations within the full frames. For example, if the exemplary region 24 shown in FIG. 1 is the first defined region, then, preferably, the second defined region is also defined by the corner pixels: (3, 10), (7, 10), (3, 12), and (7, 12).

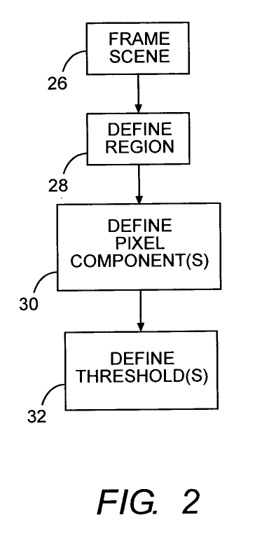

FIG. 2 shows a flow diagram of a preferred method for defining parameters according to the present invention. In step 26, the user frames the desired scene in the camera's field of view and, optionally, focuses the camera lens. The desired region is defined in step 28. As mentioned, the region will typically be rectangular. When rectangular, the region may be defined in terms of two diagonally opposed corner pixels. For example, the exemplary region 24 shown in FIG. 1 may be defined by the pixels (3, 10) and (7, 12). Preferably, the region is user selectable.

In step 30, the desired pixel component is specified. Pixels, as discussed above, are commonly defined by 3 pixel components. In one preferred embodiment, the brightness component (Y) of YUV image data is specified in step 30. In another preferred embodiment, one of the color components (U, V) of YUV data is specified in step 30. In yet another embodiment, one of the (R, G, B) color components of RGB data is specified in step 30. While these embodiments are preferred, any desired component from any desired color model may be selected. In addition, in a preferred embodiment, two or more components may be selected in the step 30. For example, both the R and G components may be selected. When two pixel components are selected, first and second parameters are calculated from the first selected component of pixels of the first and second frames, respectively, and third and fourth parameters are calculated from the second selected component of pixels of the first and second frames. And when two or more components have been specified, the image processing function is preferably triggered if the difference between the first and second parameters exceeds a first threshold, and the difference between the third and fourth parameters exceeds a second threshold. The first and second thresholds may be the same or different. The process is performed in a similar fashion when three pixel components are selected. (The present invention is described below with reference to the selection of a single pixel component, however, it should be appreciated that the aspects of the described invention may be employed when a plurality of components have been selected.) Preferably, the user specifies the pixel component(s).

According to a preferred embodiment of the invention, the values of a particular component for all pixels located within a first defined region of a first full frame are summed, thereby producing a first sum. Thereafter, the values of the same component for all pixels located within a second defined region of a second full frame are summed, thereby producing a second sum. The first and second sums are referred to, respectively, as first and second parameters. (As explained below, the first and second parameters may result from other calculations.) These two parameters are compared, and if they differ by more than a particular threshold, an image processing function is triggered. This threshold is defined in step 32. (If two or more components have been specified, two or more thresholds will be specified in step 32.) The threshold may be any value and may be user specified or predetermined.

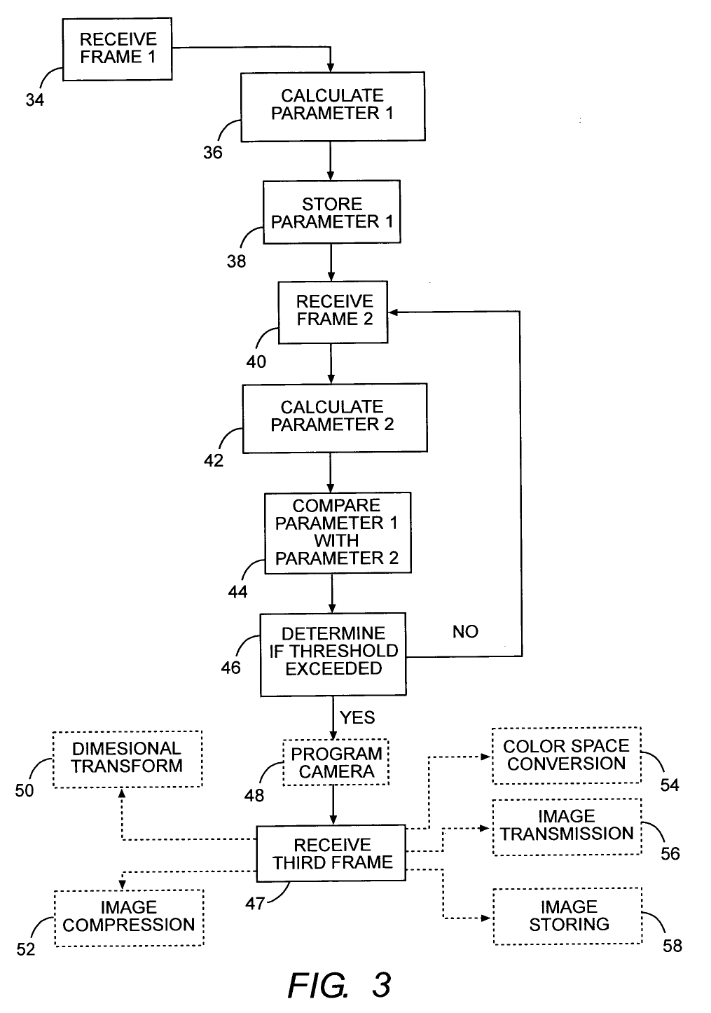

Having defined required parameters in steps 26 to 32, FIG. 3 shows a flow diagram of a preferred method for triggering an image processing function according to the present invention. The method begins with the receipt of a first frame step 34. In step 36, a first parameter is calculated from the pixels in a first region of the first frame; in one preferred embodiment, the first parameter is calculated by summing the specified component for each of these pixels. For example, the Y components of the pixels in the first region are summed. In an alternative embodiment, the calculation of the first parameter further includes determining an average of the specified component for each of these pixels. This embodiment is advantageous as, generally speaking, less memory is required to store an average value than a sum. In step 38, the first parameter is stored in a memory. Preferably, the first parameter is stored in a parameter memory dedicated for storing various parametric values, such as one or more registers.

A “second frame” is received in step 40. The second frame may be the next sequential frame generated by the camera. However, the second frame may also be some frame other than the next sequential frame. For instance, the 10^{th}, 20^{th}, 100^{th}, or 100,000^{th} frame may be the “second frame.” Selecting a frame other than next sequential frame is advantageous for conserving power. Further, as explained below, there may be a plurality of “second frames.” In step 42, a second parameter is calculated from the pixels in a corresponding second region of the second frame. The calculating of the second parameter includes summing a particular component of the pixels of the second region, where the particular pixel component is the same component specified for and used in calculating the first parameter. For example, if the Y component of the pixels in the first region were summed, the Y component of the pixels in the second region will be summed in step 42. As before, an alternative embodiment for determining the second parameter further includes determining an average of the specified component for each of these pixels.

In step 44, the first parameter is compared with the second parameter. Preferably, the parameters are compared by a subtraction operation. In step 46, it is determined whether the threshold defined in step 32 is exceeded. If the threshold is not exceeded, an image processing function is not triggered and the process returns to the step 40 where another “second frame” is received. On the other hand, if the threshold is exceeded, an image processing function is triggered. Steps 48 and 54 illustrate exemplary image processing steps.

According to the invention, the triggered function pertains to the processing of at least one later-created frame. A later-created frame is any frame created subsequent to the first and second frames. A later-created frame may be the next sequential frame after the second frame generated by a camera (or other image data source), or some later frame. A later-created frame may refer to a single frame or a plurality of frames. Processing includes programming an image capture device to capture later-created frames at a particular resolution, as well as signaling the image capture device to capture one or more later-created frames. Processing also includes storing one or more later-created frames in a memory, which is preferably an image memory, such as a volatile dedicated (e.g., a frame buffer) or general purpose memory (e.g., SRAM, SDRAM, etc.), or a non-volatile memory such as a magnetic or optical memory (e.g., flash, hard disk, etc.). Further, processing includes compressing an image, such as by using a JPEG CODEC, and dimensionally transforming an image, such as by cropping or scaling the image. In addition, processing includes transforming pixels from one color space to another. The term “processing” is not limited to the aforementioned exemplary operations, as the term is intended to encompass known image processing operations, and one of ordinary skill in the art will know of additional image processing operations.

In a first preferred embodiment, a command is issued to the camera to cause it to begin outputting images of a particular resolution in step 48. The command is issued in response to the result of the comparison (step 44) exceeding the threshold (step 46). For example, to conserve power the camera may be operating in a low-resolution mode and the first and second frames will be low-resolution images. The triggered command instructs the camera to begin outputting high-resolution images. In this embodiment, once the image data source switches to the high-resolution mode, one or more later-created frames output by the camera will be high-resolution frames. The command issued in step 48 may specify the number of later-created frames to be produced in the specified resolution, thereby specifying the capture of one or more still images, or a video of prescribed duration. For example, it may be desired to capture one or two high-resolution still images, or a minute or two of low-resolution video.

A “third frame”, which is a later-created frame, is received in step 47.

In a second preferred embodiment, a dimensional transformation operation is performed on the third frame in a step 50. The dimensional transformation operation is triggered in response to the result of the comparison (step 44) exceeding the threshold (step 46). A dimensional transformation operation changes the dimensions of image such as by cropping or scaling a frame. If a frame is cropped or down-scaled, it takes less space in memory. Thus, cropping or down-scaling a frame before storing or transmitting it is advantageous as it takes less power, conserves memory (or transmission) bandwidth, and uses less memory.

In a third preferred embodiment, a compression operation is performed on the third frame in a step 52. The compression operation is triggered in response to the result of the comparison (step 44) exceeding the threshold (step 46). A compression operation reduces the size of the data that represents an image. One of ordinary skill in the art will know of a variety of image compression techniques. One preferred method for compressing an image is with the use of a CODEC (compress-decompress) unit that employs one the standards set forth by JPEG (Joint Photographic Experts Group). Another preferred method is with an MPEG CODEC. If a frame is compressed before storing, it takes less space in memory and requires less bandwidth for transmission. Thus, compressing a frame before storing or transmitting it is advantageous as storing (or transmitting) a compressed image takes less power, conserves memory (or transmission) bandwidth, and uses less memory.

In a fourth preferred embodiment, a color space conversion operation is performed on the third frame in a step 54. The color space conversion operation is triggered in response to the result of the comparison (step 44) exceeding the threshold (step 46). For example, YUV data may be converted to RGB data, or RGB data may be converted to YUV data. Converting YUV data to RGB data places the image data in the format generally required by display devices. Moreover, converting RGB data to YUV data facilitates certain image processing operations, such as image compression. In addition, the UV components of YUV data may be subsampled, e.g., YUV 4:4:4 data may be converted to YUV 4:2:0. Converting RGB data to YUV data and subsampling the data as part of the conversion process, like JPEG compression, is a technique for reducing the size of the data that represents an image. Converting RGB to YUV and subsampling prior to storing or transmitting a frame provides the benefits similar to JPEG compression.

In a fifth preferred embodiment (step 56), the function triggered is the sending of the image over a network to another graphics display system, such as for example, to a mobile appliance or to a PC. The transmission may be via a telephone system or computer network, such as the Internet.

In a sixth preferred embodiment, the third frame is stored in a memory in step 58. The storing of the third frame in a memory is triggered in response to the result of the comparison (step 44) exceeding the threshold (step 46). The memory is preferably an image memory that is distinct from a memory for storing parameters.

It should be appreciated that the above-described embodiments may be implemented either individually or in combination. Further, while it is generally preferable to perform certain operations before storing or transmitting a later-created frame, the operations may be performed any desired sequence. For example, in one preferred embodiment, the storing of a third frame in memory alone is triggered. As another example, the following are triggered: the output resolution of the camera is changed and a later-created frame captured at the changed resolution is stored in a memory. Additionally, the following may be triggered: a later-created frame is dimensionally transformed and stored in a memory. Further, the following may be triggered: a later-created frame is compressed and stored in a memory. Moreover, the following may be triggered: a later-created frame is converted from one color space to another, sub-sampled, and stored in a memory. Other combinations may be implemented as desired. Further, as mentioned, it should be appreciated that the present invention may be employed to trigger any image processing function and that the scope of the invention is not limited to the examples shown and described here.

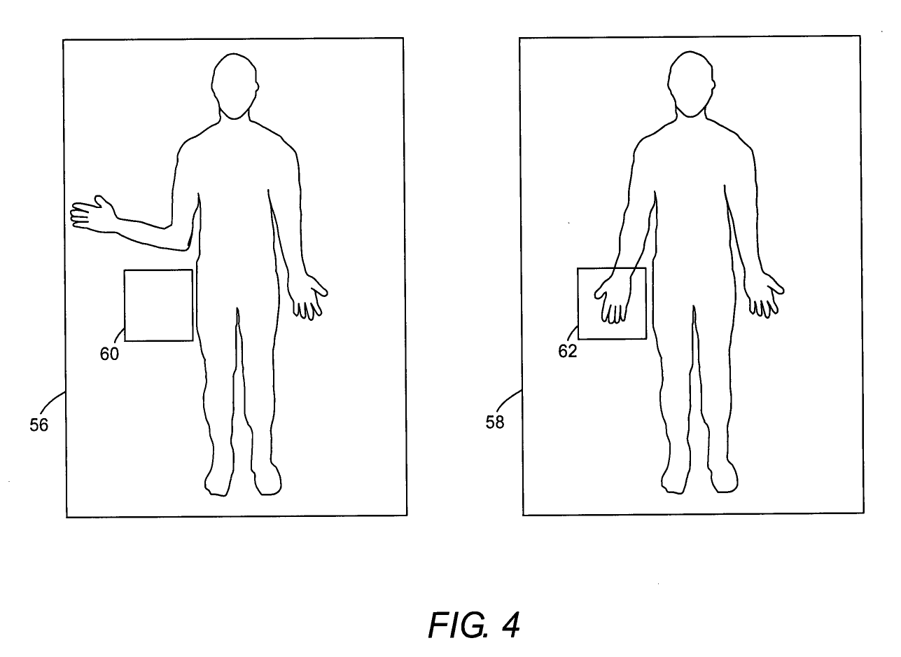

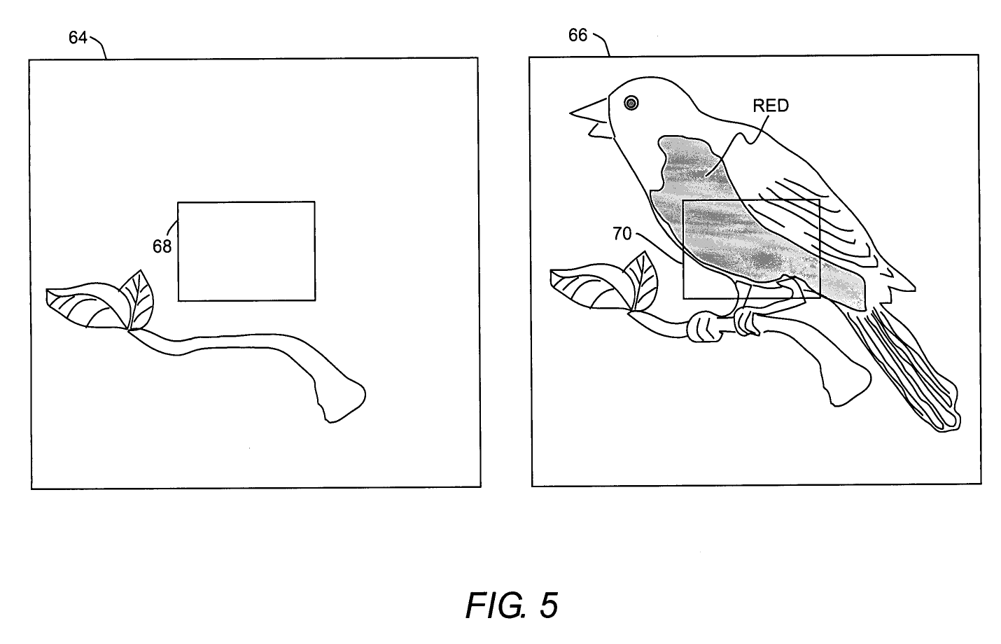

The exemplary image processing steps described above complete the description of the preferred methods as shown in FIGS. 2 and 3 according to the invention. The methods are further illustrated by way of two examples shown in FIGS. 4 and 5.

Referring to FIG. 4, first and second full frames 56, 58 of YUV image data are shown. The frames include, respectively, a first defined region 60 and a corresponding second region 62. The frames 56, 58 represent images captured by a digital camera and a particular field of view at two points in time. In this example, the first and second regions 60, 62 are user defined and correspond to the same coordinate positions within the respective frames. An individual is depicted in different poses at each point in time. In the first frame, the individual's hand is positioned outside the first region 60. In the second frame, the individual's hand is positioned within the second region 62. According to the method of FIG. 2, a user frames the desired scene, defines regions 60, 62, specifies the color component as the Y luminance component, and defines a threshold of 270,000.

According to the method of FIG. 3, the first frame 56 is received, the Y component of the pixels in the first region 60 are summed, and this sum is stored in a memory as a first parameter. The first region 60 includes only pixels of the background behind the figure. For this example, assume that the background pixels have a uniform luminance of 200. In addition, assume that the regions 60, 62 include 10,000 pixels within their borders. Thus, the first parameter equals 2,000,000.

Continuing to refer to FIG. 4, according to the method of FIG. 3, the second frame 58 is received, the Y component of the pixels in the second region 62 are summed, producing a second parameter. The second region 62 includes both pixels of the background and pixels of the hand. For this example, assume that the pixels for the hand have a uniform luminance of 100, and that the hand fills 40 percent of second region 62. Thus, the second sum equals (0.6×10,000×200)+(0.4×10,000×100), or 1,600,000. The first parameter of 2,000,000 is compared with the second parameter of 1,600,000. The difference between the two parameters is 400,000. Because the two parameters differ by more than the threshold of 270,000, an image processing function is triggered. Thus, the movement of the individual's hand to within the second region 62 causes an image processing function to be triggered.

As mentioned, in alternative embodiment, the first and second parameters are averages derived from the respective sums. In this example, if the first and second parameters are averages, the first parameter would be 200 and the second parameter would be 160. The difference of 40 would be compared to a threshold, such as 27. It will be appreciated that the use of averages requires storing smaller numbers, thereby using less memory.

Referring to FIG. 5, first and second frames 64, 66 of RGB image data are shown. The frames include, respectively, first and second regions 68 and 70. Like FIG. 4, the first and second frames 64, 66 represent images captured by a digital camera and a particular field of view at two points in time. The first and second regions 68, 70 correspond to the same coordinate positions within the respective frames. The field of view includes a tree branch and a background. At the first time, the branch is empty. At the second time, a red-breasted bird is perched on the branch partially obscuring the background.

Continuing to refer to the example shown in FIG. 5, according to the method of FIG. 2, a user frames the desired scene, defines desired regions 68, 70, specifies the color component as the red (R) component, and defines a threshold of 1,000,000. According to the method of FIG. 3, a first frame is received, the R component of the pixels in the first region 68 are summed, and this sum is stored in a memory as a first parameter. The first region 68 includes only pixels of the background. For this example, assume that the background is green foliage and the background pixels have a uniform of red component of 50. In addition, assume that the regions 68, 70 include 15,000 pixels within their borders. Thus, the first sum equals 750,000. According to the method of FIG. 3, a second frame is received, the R component of the pixels in the second region 70 are summed, producing a second parameter. The second region 70 includes pixels of the background and pixels of the bird. For this example, assume that the pixels for the bird have a uniform red component of 175, and that the bird fills 80 percent of second region 70. Thus, the second sum equals (0.2×15,000×50)+(0.8×15,000×175), or 2,250,000. The first parameter of 750,000 is compared with the second parameter of 2,250,000. The difference between the two parameters is 1,500,000. Because the two parameter differ by more than the threshold of 1,000,000, an image processing function is triggered. Thus, the movement of the bird's red-colored breast to a position within the second region 70 causes an image processing function to be triggered.

Having explained preferred methods according to the present invention for defining required parameters and for triggering an image processing function, and provided examples of these methods, one of ordinary skill in the art will recognize numerous ways in which the present invention may be implemented in hardware, software, or a combination of the two. Further, the present inventors have recognized that methods, systems, and devices according to the present invention are well suited for use in “mobile devices.” Accordingly, a preferred system and device is described next in the context of a mobile device. However, it should be appreciated that the present invention may be employed in any system or device used in any computer or communication system or device.

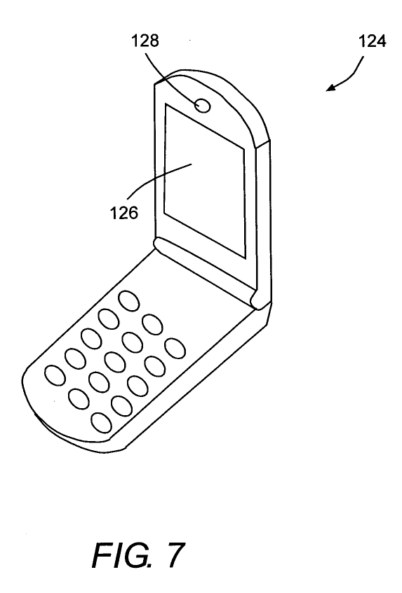

A mobile device may be, for example, a mobile telephone, personal digital assistant, digital camera, or digital music player. FIG. 7 illustrates one example of a mobile device. FIG. 7 is a diagram of a camera-equipped mobile telephone illustrating one preferred context for the present invention. The mobile telephone 124 includes a display screen 126 and a camera 128.

Mobile devices commonly have a graphics display system that includes a host, a camera, and a display device. They also typically include a graphics display controller for driving the display device and interfacing the host, camera, and display device to one another. The host may be, for example, a CPU or a digital signal processor (“DSP”). The graphics controller commonly includes an embedded memory for storing image data. Mobile devices typically rely primarily on a battery for power. To maximize battery life in these devices, it is important to minimize power consumption. It is also important to minimize the size of the memory, which reduces cost and also reduces power consumption.

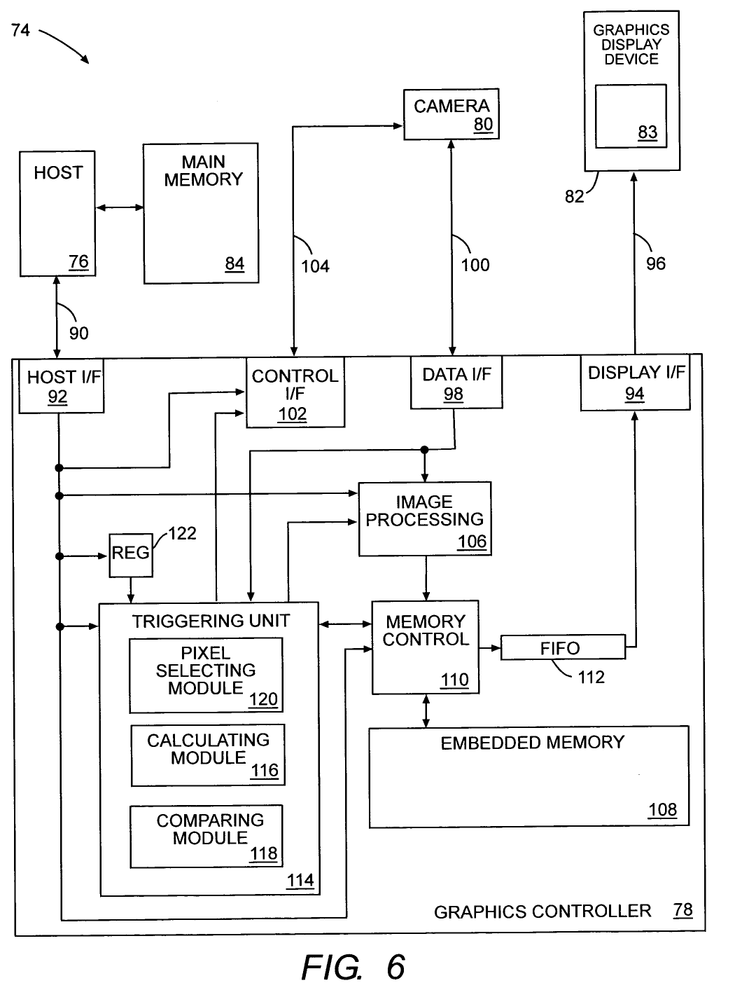

FIG. 6 is a block diagram of a preferred digital imaging and display system 74 that includes a graphics controller and a graphics display device according to the present invention. The system 74 may be or be included in any computer or communication system or device. In particular, the system 74 is suitable for use in a mobile device. Where the system 74 is included in a mobile device, it is typically powered by a battery (not shown).

The system 74 includes a host 76, a graphics display controller 78, a camera module 80, a graphics display device 82, and a main memory 84. The system 74 may include additional components. The host 76 is typically a microprocessor, but may be a DSP, computer, or any other type of controlling device adapted for controlling digital circuits. The graphics controller 78 drives the display device and interfaces the host and the camera module with the display device. Preferably, the graphics controller 78 is a separate IC from the remaining elements of the system, that is, the graphics controller is “remote” from the host, camera, and display device. The display device includes at least one display screen 83. Preferably the display device is an LCD, but any device(s) capable of rendering pixel data in visually perceivable form may be employed.

The host 76 communicates with the graphics controller 78 over a bus 90 that is coupled to a host interface 92 in the graphics controller. The graphics controller 78 includes a display device interface 94 for interfacing the graphics controller with the display device 82 over a display device bus 96. In addition, the graphics controller 78 includes a camera interface 98 (“CAM I/F”) for receiving pixel data output on a bus 100 from the camera 80. Preferably, the bus 100 is a parallel bus. The camera 80 is programmatically controlled through a camera control interface 102 (“CONTROL I/F”). A bus 104 couples the camera control interface 102 to the camera 80. The bus 104 is preferably an inter-IC or I²C bus.

A number of image processing operations may be performed on data provided by an image data source, such as the host or the camera. Such image processing operations may be performed by units included in an image processing block 106. The image processing block 106 may include, for example, a CODEC for compressing and decompressing image data, and a resizer for scaling and cropping an image. In addition, the image processing block 106 may include a color space converting unit for converting image data from RGB to YUV, YUV to RGB, or for performing other color space conversions. Preferably, the color space converting unit is adapted for sub-sampling YUV image data. The details of the image processing block will be known to one of ordinary skill in the art, but as they are not important to the present invention they are omitted for purposes of clarity.

The system 74 is preferably adapted for transmitting image data to a mobile appliance, PC, or other device via a telephone system or computer network. For instance, the logic for transmitting image data may be included, in part within, the graphics display controller 78, and, in part, within, the host and other components of the system 74 that are not shown in FIG. 6. As an example, the image processing block 106 may be adapted to provide image data to the host 76 via the host I/F 92, where the host 76 completes the transmission.

In a preferred embodiment, the graphics controller 78 includes an embedded memory 108 for storing image and other data. In other embodiments, however, the memory 108 may be remote from the graphics controller. Data are stored in and fetched from the memory 108 under control of a memory controller 110. The memory 110 is preferably an SRAM, however, any type of memory may be employed. Typically, frames of image data that are ready for display are stored in the embedded memory 108, and thereafter fetched and transmitted through at least one display pipe 112, which is preferably a FIFO buffer, to the display device 82 via the display device interface 94 and the bus 96.

In a preferred embodiment, the graphics controller 78 includes a triggering unit 114 and a parameter memory for storing parameters, such as parameters for delineating the first and second regions, parameters for defining one or more pixel components, parameters for defining one or more comparison thresholds, and parameters calculated from at least a first and second region. Preferably, the parameter memory is a set of registers 122. Further, the parameter memory is preferably distinct from a memory for storing full frames of image data, such as the memory 108 or main memory 84. The parameters stored in the registers 122 are preferably written to the registers by the host 76. Moreover, the graphics display system 74 preferably includes software that provides a user interface permitting the user to define the parameters that are ultimately stored in the registers. The registers 122 are coupled with the host 76 and the triggering unit 114. In an alternative embodiment, the registers 122 are provided within the embedded memory 108.

The triggering unit 114 is adapted for triggering a function that pertains to processing at least one later-created frame, which is created subsequent to first and second frames. Further, the triggering unit 114 is adapted for calculating parameters from the first and second frames, and comparing the parameters. Moreover, the triggering unit 114 is adapted for identifying pixels within first and second regions of the first and second frames. In a preferred embodiment, the triggering unit comprises a calculating module 116, a comparing module 118, and a pixel selecting module 120.

The calculating module 116 is adapted for calculating the first parameter from pixels of the first region of the first frame and a second parameter from pixels of a corresponding second region of a second frame. In one embodiment, the calculating module 116 calculates the first and second parameters by summing pixel components. In another embodiment, the calculating module 116 calculates the first and second parameters by calculating an average of the pixel components. In addition, the calculating module 116 is adapted for storing the first parameter in the parameter memory 122 and for providing the second parameter to the comparing module 118. The calculating module 116 “learns” the specified pixel component by reading the parameter memory 122.

The comparing module 118 reads a comparison threshold from the parameter memory 122. In addition, the comparing module 118 reads the first parameter (calculated by the calculating module 116) from the parameter memory 122. After the calculating module 116 has calculated the second parameter, it provides the second parameter to the comparing module 118 for comparison with the first parameter. Preferably, the comparison is performed by subtracting one parameter from the other. If the difference between the first and second parameters exceeds the comparison threshold, the comparing module 118 is adapted for triggering a function that pertains to processing at least one later-created frame, which is created subsequent to the first and second frames.

The pixel selecting module 120 serves to select pixels in a defined region from a stream of image data provided by the camera. The pixel selecting module 120 “learns” how the first and second regions are delineated by reading the parameter memory 122. In one preferred embodiment, the image data is streamed in raster order and the pixel selecting module 120 includes column and row counters. When the counters indicate that a pixel in the data stream is within the defined region, the pixel selecting unit causes the calculating module 116 to add the specified pixel component of the received pixel to a running total for the region. When the counters indicate that all of the pixels within the defined region of a frame have been received, the pixel selecting module 120 causes additional action to be taken, depending on which frame has been received. If the calculating unit 116 has been summing pixel components for a first region, at the end of the first frame the module 120 signals the calculating unit 116 so that it may store a first parameter in the parameter memory. On the other hand, if the calculating unit 116 has been summing pixel components for a second region, at the end of the second frame, the module 120 signals the calculating unit 116 so that it may provide the second parameter to the comparing module 118.

One of ordinary skill in the art will appreciate that the modules 116, 118, and 120 may be implemented in a variety of ways, such as combinational logic, discrete logic components (adders, subtracters, counters, etc.), or hardware code.

The graphics display system 74 preferably includes software that provides a user interface permitting the user to define the parameters that are ultimately stored in the parameter memory. In one embodiment, the user interface for defining the first and second regions, permits the user to select from a plurality of predefined regions. For example, a 100×100 frame may be subdivided into 10×10 blocks of pixels. A user may select one of the one hundred predefined 10×10 blocks using up, down, left, and right arrow keys. In another embodiment of a user interface for defining the first and second regions, a user may define the regions using a pen and a touch-sensitive screen. In addition, one of ordinary skill in the art will know of other techniques for defining the first and second regions.

In one embodiment, the user interface for defining parameters consists of menus for inputting or selecting specific parameters, such as brightness or color. In another embodiment, the attributes may be input by positioning or focusing the camera on an object of the desired color or brightness. In this embodiment, an object of desired color or brightness is captured and the binary values of its pixels are used to program the parameter registers. For instance, if it is desired to trigger an image processing function in response to the coloring of a particular species of wildlife, a stuffed animal may be placed in the selected region in the field of view, and the average pixel value is captured. Thereafter, the object is removed and the average pixel value of the selected region in the field of view is captured. The difference between the average pixel values may be used for determining an appropriate threshold.

While the present invention has been described in terms of detection of an object such as an animal or a hand entering a defined region and thus changing the brightness or color of that region, it should be appreciated that the invention may be employed to detect the absence of an object for the defined region. Further, the present invention has been described in terms of a single defined region. However, the invention may be employed to detect changes in a plurality of defined regions.

The present invention has been described for use with color images. It should be appreciated that the invention may also be employed with gray-scale images.

The present invention has been described for use with image data received from a camera that is integrated in the system or device. It should be appreciated that the invention may be practiced with image data that is received from any image data source, whether integrated or remote. For example, the image data may be transmitted over a network by a camera remote from the system or device incorporating the present invention.

The methods, systems, and devices of the present invention have been described as summing or averaging the values of a single component for all pixels located within defined regions of a two frames. As mentioned, it should be appreciated that the invention is not limited to the use of a single pixel component. In some circumstances it will be advantageous to sum or average two or more components. For example, in one preferred embodiment, the red and blue components of RGB data are summed, with a difference a unique comparison threshold specified for each component.

Any of the operations described herein that form part of the invention are useful machine operations. The invention also relates to a device or an apparatus for performing these operations. The apparatus may be specially constructed for the required purposes, such as the described mobile device, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include flash memory, hard drives, network attached storage (NAS), read-only memory, random-access memory, CD-ROMs, CD-Rs, CD-RWs, magnetic tapes, and other optical and non-optical data storage devices. The computer readable medium can also be distributed over a network-coupled computer system so that the computer readable code is stored and executed in a distributed fashion.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes or purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the invention is defined and limited only by the claims which follow.

We claim:

1. A method for triggering a processing function for a frame of image data, comprising:
(a) calculating a first parameter from pixels of a first region of a first frame, the calculating of the first parameter including summing at least one particular component of the pixels of the first region;
(b) calculating a second parameter from pixels of a corresponding second region of a second frame, the calculating of the second parameter including summing the particular component of the pixels of the second region;
(c) comparing the first parameter with the second parameter; and
(d) triggering a function if a particular difference between the first and second parameters is detected, wherein the triggered function pertains to processing at least one later-created frame that is created subsequent to the first and second frames.

2. The method of claim 1, wherein the triggered function includes storing at least one later-created frame.

3. The method of claim 2, wherein the triggered function includes causing a later-created frame to be captured at a resolution different from the resolution of the first frame.

4. The method of claim 2, wherein the triggered function includes causing a later-created frame to be compressed.

5. The method of claim 2, wherein the triggered function includes causing a later-created frame to be dimensionally transformed.

6. The method of claim 2, wherein the triggered function includes causing a later-created frame to be converted from one color space to another color space.

7. The method of claim 1, wherein the triggered function includes causing a later-created frame to be transmitted to a remote device.

8. The method of claim 1, wherein the at least one particular pixel component is at least two components.

9. The method of claim 1, wherein the calculating of the first parameter includes computing an average of the at least one particular component of the pixels of the first region, and the calculating of the second parameter includes computing an average of the particular component of the pixels of the second region.

10. A graphics display controller for use in an image processing system, comprising:
a parameter memory for storing parameters for delineating a first region of a first frame, a pixel component parameter for specifying at least one particular pixel component, a first parameter, and at least one comparison threshold; and
a triggering unit including:
(a) a calculating element for:
calculating the first parameter from pixels of the first region of the first frame and a second parameter from pixels of a corresponding second region of a second frame, and
for storing the first parameter in the parameter memory, wherein the calculating of the first and second parameters includes summing pixel components; and
(b) a comparing element for comparing the first parameter with the second parameter and for a causing a function to be triggered if at least a first condition that a difference between the first and second parameters exceeds the comparison threshold is satisfied, wherein the comparing element is adapted for triggering a function that pertains to processing at least one later-created frame created subsequent to the first and second frames.

11. The graphics display controller of claim 10, further comprising an image memory for storing the at least one later-created frame, wherein the triggered function includes storing at least one later-created frame.

12. The graphics display controller of claim 10, further comprising a camera interface for programming an image capture device, wherein the triggered function causes a later-created frame to be captured at a resolution different from the resolution of the first frame.

13. The graphics display controller of claim 10, further comprising a CODEC for compressing an image, wherein the triggered function causes a later-created frame to be compressed.

14. The graphics display controller of claim 10, further comprising an image resizer for dimensionally transforming an image, wherein the triggered function causes a later-created frame to be dimensionally transformed.

15. The graphics display controller of claim 10, further comprising a color space conversion element, wherein the triggered function causes a later-created frame to be converted from one color space to another color space.

16. The graphics display controller of claim 10, further comprising a transmitting element for transmitting an image, wherein the triggered function causes a later-created frame to be transmitted to a device remote from the graphics display controller.

17. The display controller of claim 10, wherein the at least one particular pixel component is two components, and wherein (a) the calculating element is further adapted for calculating a third parameter from the pixels of the first region and a fourth parameter from pixels of the corresponding second region, and for storing the third parameter in the memory, wherein the calculating of the third and fourth parameters includes summing pixel components, and (b) the comparing element is adapted for comparing the third parameter with the fourth parameter and for causing the function to be triggered if a second condition that a difference between the third and fourth parameters exceeds a second comparison threshold is satisfied.

18. The display controller of claim 10, wherein the calculating of the first parameter includes computing an average of the at least one particular component of the pixels of the first region, and the calculating of the second parameter includes computing an average of the particular component of the pixels of the second region.

19. A computer system, comprising:
a host;
a display device;
an image capture device; and
a graphics display controller, including:
a parameter memory for storing parameters for delineating a first region of a first frame, a pixel component parameter for specifying at least one particular component, a first parameter, and at least one comparison threshold;
an image memory;
a triggering unit, including:
(a) a calculating element for:
calculating the first parameter from pixels of the first region of the first frame and a second parameter from pixels of a corresponding second region of a second frame, and
for storing the first parameter in the parameter memory, wherein the calculating of the first and second parameters includes summing pixel components; and
(b) a comparing element for comparing the first parameter with the second parameter and for a causing a function to be triggered if a difference between the first and second parameters exceeds the comparison threshold, wherein the comparing element is adapted for triggering a function that pertains to processing at least one later-created frame created subsequent to the first and second frames.

20. The computer system of claim 19, further comprising a transmitting element for transmitting an image, wherein the triggered function causes a later-created frame to be transmitted to a device remote from the computer system.
